(19) United States
(12) Patent Application Publication
(10) Pub. No.: US 2005/0289228 A1
(43) Pub. Date: Dec. 29, 2005

(54) System and method for managing a change to a cluster configuration

(75) Inventors: Koneru Srikanth, Santa Clara, CA (US); Kripakaran Karlekar, Sunnyvale, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 10/877,892

(22) Filed: Jun. 25, 2004

(51) Int. Cl. G06F 15/177

(52) U.S. Cl. 709/220

(57) ABSTRACT

An apparatus and method are directed to managing a configuration of a cluster of members. The invention employs an atomic cluster configuration approach that includes applying a change to the configuration uniformly across the members in the cluster. Each member within the cluster is initialized to a transaction mode. If all members are in the transaction mode, a change is provided to each member, which evaluates the received change. If the change is determined to be unacceptable for any of the members, the change is determined to be globally unacceptable, and is rejected for all the members in the cluster.

### FIELD OF THE INVENTION

The invention relates generally to computing management, and more particularly but not exclusively to a method and system for managing a configuration of members within a cluster.

### BACKGROUND OF THE INVENTION

One consideration of organizations that supply network services is that the computing equipment provides a high degree of availability. To meet this consideration, technology has become available to loosely couple several computing devices into a group, known as a cluster, to provide a set of services, resources, and the like, over a network. A failure of a computing device within the cluster (e.g., a cluster member), may affect the operation of the cluster minimally, as the remaining cluster members are configured to share the work of the failed cluster member in a virtually seamless manner.

In addition to traffic management, the cluster may also be configured to provide other services, including Domain Name Systems services, user authentication, authorization, and accounting (AAA) services, collection of operational statistics, and the like. These types of services are typically known as “Network Management” services.

The act of configuring the computing devices into the cluster is called cluster configuration. One act typically considered within cluster configuration includes change management of the cluster. It is with respect to cluster change management considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows a functional block diagram illustrating another embodiment of an environment for practicing the invention;

FIG. 3 shows one embodiment of a network device that may be employed in a system implementing the invention;

FIG. 4 illustrates a logical flow diagram generally showing one embodiment of a process for managing a change to a cluster configuration; and

FIG. 5 illustrates a logical flow diagram generally showing one embodiment of a process of responding to a configuration change by a cluster member, in accordance with the invention.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

Briefly stated, the invention is directed towards a system, apparatus, and method for managing a configuration of a cluster of network devices. The invention employs an atomic cluster configuration approach that applies a change to the configuration uniformly across the members in the cluster. Each member within the cluster is directed to transition to a transaction mode. If all cluster members are in the transaction mode, a change is provided to each cluster member. Each cluster member evaluates the received change. If the change is determined to be unacceptable for any of the cluster members, the change is determined to be globally unacceptable, and is rejected for all the members in the cluster. If the configuration change is acceptable for all members of the cluster, then all cluster members are directed to commit to the configuration change by, in part, applying the configuration change.

Illustrative Operating Environment

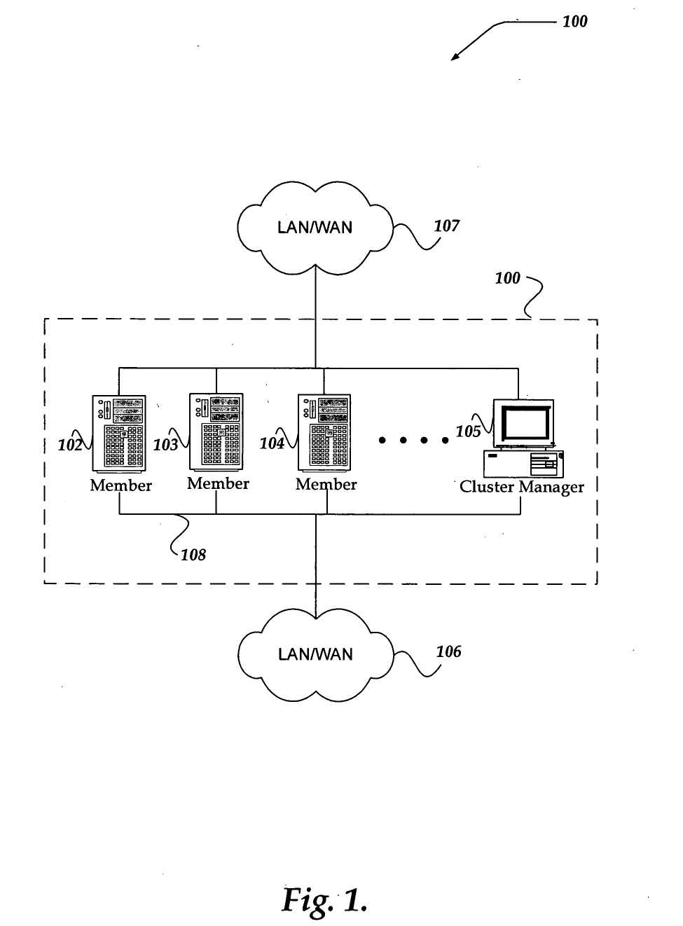

FIG. 1 illustrates one embodiment of an environment in which the invention may operate. Not all the components may be required to practice the invention, and variations in the arrangement and type of the components may be made without departing from the spirit or scope of the invention.

As shown in the figure, cluster system 100 includes Local Area Network/Wide Area Networks (LAN/WANs) 106 and 107 and cluster 101. Cluster 101 includes cluster members 102-104, and cluster manager 105. Cluster 101 is in communication with LAN/WANs 106 and 107.

Cluster members 102-104, and cluster manager 105 may be in communication with LAN/WANs 106 and 107 through a plurality of networks. For example, although not illustrated, a plurality of network connections may exist between cluster members 102-104, cluster manager 105 and LAN/WAN 107. A plurality of network connections may further exist between cluster members 102-104, cluster manager 105 and LAN/WAN 106. However, for clarity, only network 108 is illustrated in FIG. 1. Network 108 may include virtually any local area network (LAN), including, but not limited to Ethernet, 802.3, and the like. In one embodiment, network 108 is a protocol network. A protocol network includes virtually any network, including its interconnections, and the like, that is employed for an exchange of a cluster protocol message.

Cluster 101 typically is configured to include loosely coupled network devices that may cooperate to provide another device with access to a service, resource, and the like. In one embodiment, cluster 101 is configured to optimize a message throughput by adaptively load balancing cluster members 102-104. Cluster 101 may further be configured to provide other network management services, including, but not limited to Domain Name Services, traffic management, and the like.

Cluster members 102-104 may be any network device capable of sending and receiving a packet over the network in a cluster architecture. In one embodiment, cluster members 102-104 are configured to operate as a protocol stack processor for a received message packet. The set of such devices may include devices that typically connect using a wired communications medium such as personal computers, multiprocessor systems, microprocessor-based or programmable consumer electronics, network PCs, and the like, that are configured to operate as a cluster device. The set of such devices may also include devices that typically connect using a wireless communications medium such as a mobile device, including but not limited to cell phones, smart phones, pagers, walkie talkies, radio frequency (RF) devices, infrared (IR) devices, laptops, CBs, integrated devices combining one or more of the preceding devices, and the like, that are configured as a cluster device. Alternatively, cluster members 102-104 may be any device that is capable of connecting using a wired or wireless communication medium such as a PDA, POCKET PC, wearable computer, and any other device that is equipped to communicate over a wired and/or wireless communication medium, operating as a cluster device.

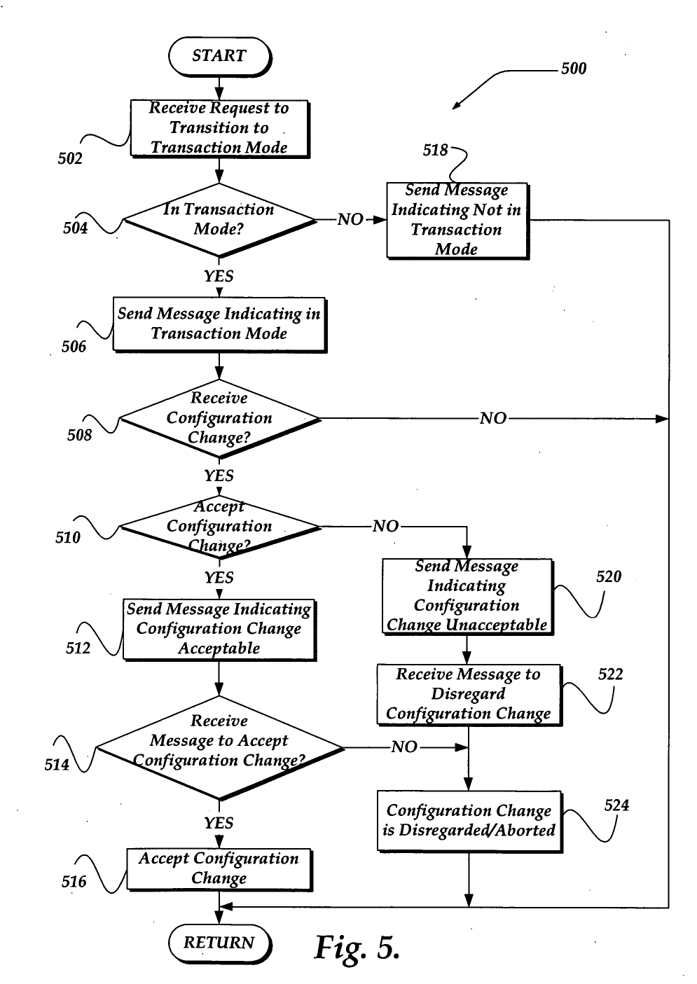

Moreover, each of cluster member within cluster members 102-104 may include an agent, client application, and the like, that is configured to communicate a packet between itself and cluster manager 105. For example, the client application may direct a cluster member to lock itself during a transaction mode with cluster manager 105, such that the cluster member may receive a configuration change from a predetermined source; determine the acceptance of the received configuration change; and to provide an indication of the acceptance of the received configuration change to cluster manager 105. The client application be may further configured to commit to the configuration change as substantially permanent, remove the received configuration change, and the like, based, in part, on information received from cluster manager 105. The agent, client application, and the like, may further employ process 500 described below in more detail in conjunction with FIG. 5.

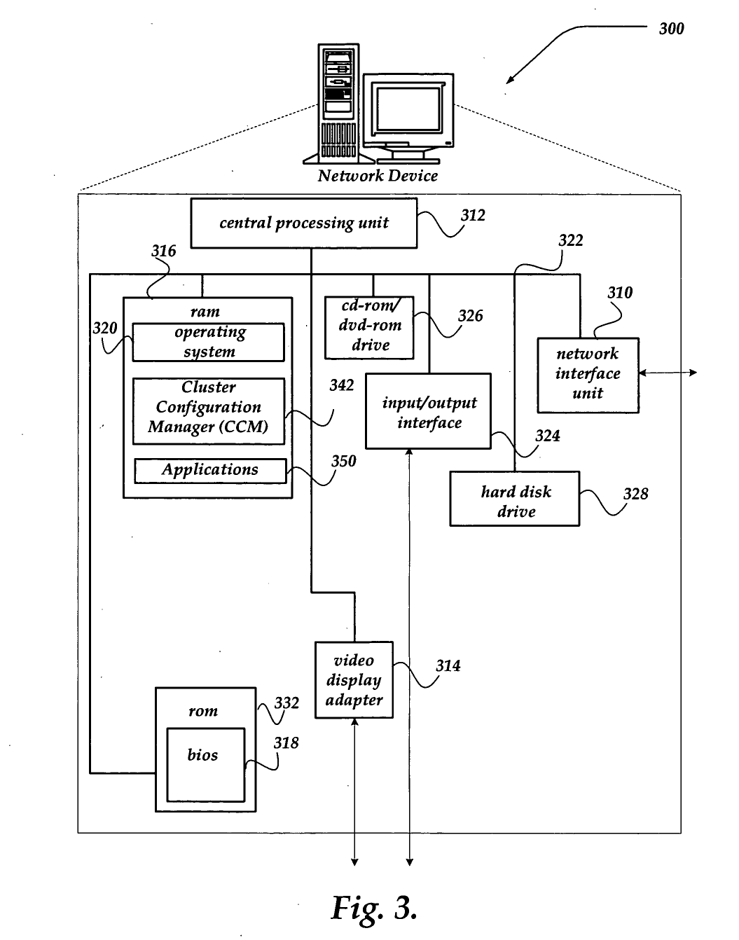

Cluster manager 105 is described in more detail in conjunction with FIG. 3. Briefly, however, cluster manager 105 includes virtually any network device that is configured to operate as a cluster management network device to enable change management of the cluster configuration. The set of such devices may include, but is not limited to personal computers, multiprocessor systems, microprocessor-based or programmable consumer electronics, network PCs, mobile devices, including, but not limited to cell phones, smart phones, pagers, walkie talkies, radio frequency (RF) devices, infrared (IR) devices, CBs, integrated devices combining one or more of the preceding devices, a PDA, POCKET PC, wearable computer, and any other device that is equipped to communicate over a wired and/or wireless communication medium, to manage configuration changes to cluster 101.

LAN/WANs 106 and 107 are enabled to employ any form of computer readable media for communicating information from one electronic device to another. In addition, LAN/WANs 106 and 107 can include the Internet in addition to local area networks (LANs), wide area networks (WANs), direct connections, such as through a universal serial bus (USB) port, other forms of computer-readable media, and any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, LAN/WANs 106 and 107 may include any communication method by which information may travel between network devices.

Typically, LAN/WAN 106 may include a content server, application server, and the like, to which cluster 101 enables access to for another network device residing within LAN/WAN 107.

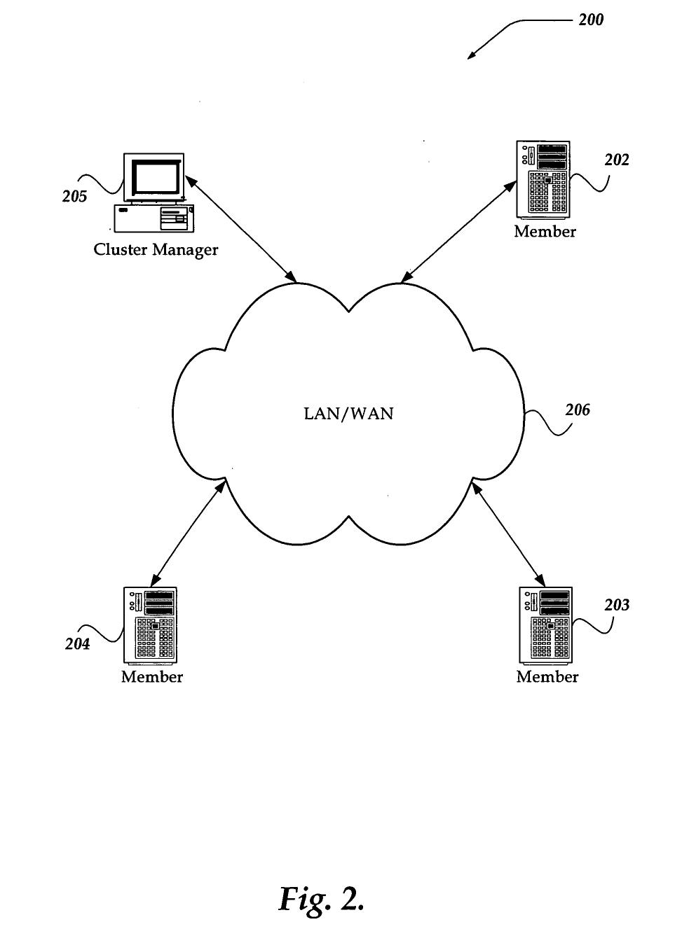

FIG. 2 shows a functional block diagram illustrating another embodiment of an environment for practicing the invention. Not all the components may be required to practice the invention, and variations in the arrangement and type of the components may be made without departing from the spirit or scope of the invention.

As shown in the figure, cluster system 200 includes Local Area Network/Wide Area Networks (LAN/WANs) 206, cluster members 202-204, and cluster manager 105. LAN/WANs 206 enables communication between cluster members 202-204 and cluster manager 205.

Cluster members 202-204 operate substantially similar in some ways to cluster members 102-104 in FIG. 1, and different in other ways. Cluster manager 205 may also operate substantially similar in some ways to cluster manager 105 in FIG. 1, and different in other ways. Moreover, LAN/WAN 206 may operate substantially similar in some ways to LAN/WAN 106-107, but different in other ways. For example, cluster members 202-204 and cluster manager 205 may be configured to communicate over LAN/WAN 206 employing a secure encrypted protocol, including, but not limited to SSL, TLS, and the like. Moreover, in one embodiment, LAN/WAN 206 includes the Internet.

FIG. 3 illustrates a functional block diagram of one embodiment of a network device 300, which may operate as a cluster manager. Network device 300 may include many more components than those shown. The components shown, however, are sufficient to disclose an illustrative embodiment for practicing the invention.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300.

As illustrated in FIG. 3, network device 300 also can communicate with the Internet, or some other communications network, such as LAN/WANs 106-107 in FIG. 1, and LAN/WAN 206 in FIG. 2, via network interface unit 310, which is constructed for use with various communication protocols including, but not limited to the TCP/IP protocol, UDP/IP protocol, and the like. Network interface unit 310 is sometimes known as a transceiver or transceiving device.

Network device 300 may also include an SMTP handler application for transmitting e-mail, an HTTP handler application for receiving and handing HTTP requests, and an HTTPS handler application for handling secure connections. The HTTPS handler application may initiate communication with an external application in a secure fashion. Network device 300 is not limited however, to these handler applications, and many other protocol handler applications may be employed by network device 300 without departing from the scope of the invention.

Network device 300 may also include input/output interface 324 for communicating with external devices, such as a mouse, keyboard, scanner, or other input devices not shown in FIG. 3. Likewise, network device 300 may further include additional mass storage facilities such as CD-ROM/DVD-ROM drive 326 and hard disk drive 328. Hard disk drive 328 is utilized by network device 300 to store, among other things, application programs, databases, and the like.

The mass memory as described above illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In one embodiment, the mass memory stores program code and data for implementing operating system 320. The mass memory may also store additional program code and data for performing the functions of network device 300. One or more applications 350, and the like, may be loaded into mass memory and run on operating system 320. As shown in the figure, Cluster Configuration Manager (CCM) 342 is an example of an application that may run on operating system 320.

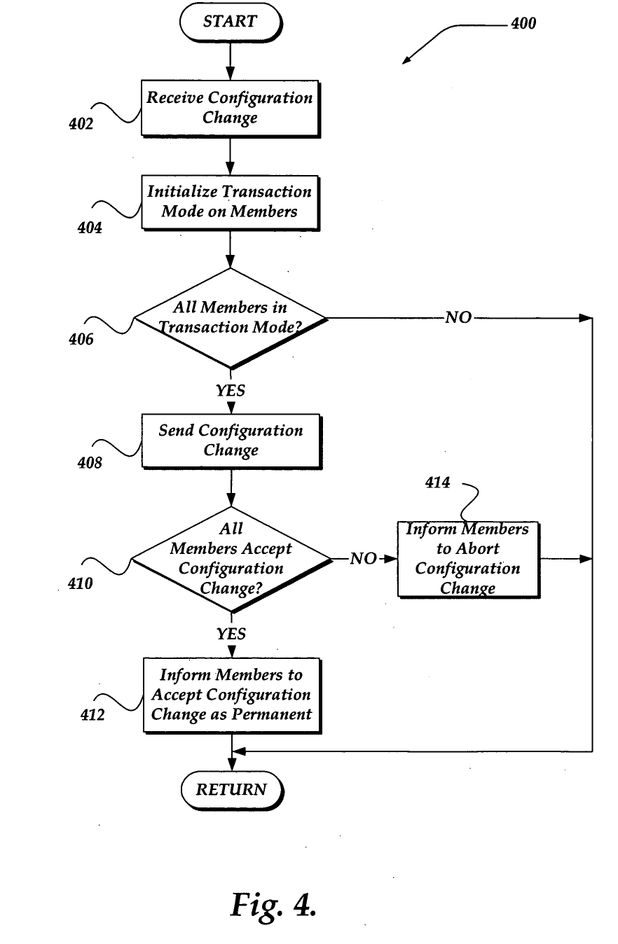

CCM 342 is arranged to manage configuration changes across members within a cluster. CCM 342 may operate to receive a configuration change, and direct cluster members to transition to a transaction mode. CCM 342 may send the configuration change to each cluster member. It is desirable, although not required, that a given configuration change be accepted by all members of the cluster. For example, where the configuration change includes a change to an Independent Internet Protocol (IIP) address, such configuration change may be made by a single cluster member. In another example, it may be desirable that each member of the cluster be synchronized to a same clock time. It may also be desirable for each member to include a substantially similar host configuration, network management protocol version/configuration, and the like. Similarly, it may be desirable, that each cluster member employ the same Cluster IP (CIP) address. In any event, for global cluster member changes, CCM 342 may employ an atomic cluster configuration approach where the global configuration change is applied uniformly across each member of the cluster. If it is determined that the configuration change is unacceptable for any cluster member, the configuration change is deemed globally unacceptable for the cluster and is rejected. This approach enables the cluster from improperly accepting an unacceptable cluster configuration by a cluster member. CCM 342 may employ, for example, a process substantially similar to process 400, which is described in more detail below in conjunction with FIG. 4, to manage the configuration change.

Illustrative Operation

The operation of certain aspects of the invention will now be described with respect to FIGS. 4-5. FIGS. 4 and 5 may be viewed as illustrating complementary processes, one executing on a cluster manager, and the other executing on a cluster member.

As such, FIG. 4 illustrates a logical flow diagram generally showing one embodiment of a process for managing changes to a cluster configuration. Process 400 of FIG. 4 may be implemented within cluster manager 105 of FIG. 1, as well as within cluster manager 205 of FIG. 2.

As shown in FIG. 4, process 400 begins, after a start block, at block 402, where a configuration change is received. The configuration change may be received from any of a variety of sources, including, but not limited to, over a network, from another device, through an entry by an administrator, a script, another application, process, and the like.

The received configuration change may include any of a variety of changes that are directed to all members of the cluster. Upon receipt of the configuration change, processing continues to block 404, where a message is sent to each cluster member that is directed towards initializing a transaction mode with each cluster member. As part of the transaction initialization, each cluster member is to perform a locking response such that it is ready to receive the configuration change, and change sources may be ‘locked out.’

Processing flows next to decision block 406, where a determination is made whether each cluster member is locked in transaction mode, and ready to receive the configuration change. Such determination may be made, for example, by receiving a message from each cluster member indicating a status of the cluster member. In one embodiment, the determination is made when a status is not received by all cluster members. This may arise, for example, if a cluster member is ‘off-line,’ a connection with the cluster member failed, and the like. In any event, if it is determined that all cluster members are not in transaction mode, processing returns to a calling process to perform other actions. The process may further provide information to an administrator, another process, and the like, indicating which cluster member is not in transaction mode. Given which cluster member is not in transaction mode, an appropriate action may be taken, including, but not limited to, re-entering process 400 after a predetermined period of time, after performing a reset, or the like, of the identified cluster member, removing the identified cluster member from the cluster, and the like.

If, however, at decision block 406, it is determined that all cluster members are in transaction mode, processing flows to block 408 where the configuration change is sent to each cluster member. In one embodiment, the configuration change is sent to each cluster member employing a change protocol. The change protocol may be sent to each cluster member over a predetermined protocol network, towards a predetermined port, and the like. As each cluster member receives the configuration change, the configuration change is evaluated by the cluster member to determine if it is acceptable for that cluster member.

Process 400 continues to decision block 410, where a determination is made whether the configuration change is acceptable by all cluster members. In one embodiment, such determination is made based on receiving another message from each cluster member. If the configuration change is acceptable for all cluster members, processing flows to block 412; otherwise, processing flows to block 414.

At block 412, a message is sent to each cluster member indicating that the configuration change is to be committed to by the cluster member. Processing then returns to the calling process to perform other actions.

At block 414, however, if all cluster members did not accept the configuration change, a message is sent to each cluster member indicating that the configuration change is to be aborted, or otherwise disregarded. That is, the configuration change is not to be applied. Processing then returns to the calling process to perform other actions.

FIG. 5 illustrates a logical flow diagram generally showing one embodiment of a process of responding to a configuration change by a cluster member, in accordance with the invention. Process 500 of FIG. 5 may be implemented within cluster members 102-104 of FIG. 1, as well as within cluster members 202-204 of FIG. 2.

Process 500 of FIG. 5 begins, after a start block, at block 502, where a request to transition to transaction mode is received. In response, the cluster member receiving the request attempts to lock itself to receive the configuration change from a cluster manager, and not from another source.

Processing continues next to decision block 504, where a determination is made whether the cluster member is in transaction mode. The cluster member may not transition to transaction mode for any of a variety of reasons, including, but not limited to, the device is currently performing another action that may not be interrupted, the device is unable to understand a transaction mode mechanism, unable to perform a lock, and the like. If it is determined that the cluster member is not in transaction mode, processing branches to block 518, where a message is sent indicating that the cluster member is not in transaction mode. Process proceeds then to return to a calling process to perform other actions.

If, however, at decision block 504, it is determined that the cluster member is in transaction mode, processing proceeds to block 506, where a message is sent indicating that the cluster member is in transaction mode. Processing continues next to decision block 508, where a determination is made whether a configuration change is received. A configuration change may not be received for any of a variety of reasons, including, but not limited to the transaction being terminated because all cluster members are not in transaction mode, a network failed, and the like. In any event, if a configuration change is not received, processing proceeds to return to the calling process to perform other actions; If however, a configuration change is received, processing flows to decision block 510.

At decision block 510, a determination is made whether the received configuration change is acceptable. A configuration change may not be acceptable for any of a variety of reasons. For example, the configuration change may request storage space for a file, but the cluster member does not have sufficient storage space for the file. As another example, the configuration change may request a change in the CIP for the cluster, but the change in the CIP may conflict with the cluster member's IIP, and the like. In any event, if it is determined that the configuration change is unacceptable, processing branches to block 520; otherwise, processing proceeds to block 512.

At decision block 510, however, if it is determined that the configuration change is unacceptable, processing proceeds to block 520, where a message is sent indicating that the configuration change is unacceptable. The message may include information sufficient to indicate a reason that the configuration change is unacceptable. Processing next continues to block 522, where a message is received that indicates that the configuration change is to be aborted, not made substantially permanent, or otherwise disregarded. Processing flows to block 524, where the configuration change is aborted, rolled-back, discarded, or otherwise disregarded by the cluster member. After the completion of block 524, processing returns to the calling process to perform other actions.

At block 512, a message is sent indicating that the configuration change is acceptable. Processing continues to decision block 514, where a determination is made whether a message is received that indicates the configuration change is to be committed to. The configuration change may not be committed to, for example, when another cluster member in the cluster has indicated that the configuration is unacceptable for that cluster member. In any event, if the configuration change is not globally acceptable for all cluster members processing flows to block 524, where implementation of the configuration change is disregarded, rolled-back, or the like, such that it is not committed to, or applied as substantially permanent. Processing then returns to the calling processing to perform other actions. However, if the configuration change is to be made permanent processing continues to block 516. At block 516, the cluster member commits, or otherwise applies, the configuration change as a permanent change (that is until another configuration change indicates a change to that change). Processing then returns to the calling processing to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A method for managing a configuration change to a cluster, comprising:
receiving the configuration change;
sending the configuration change to each member of the cluster;
determining if the configuration change is unacceptable by any member of the cluster, and if it is determined that the configuration change is unacceptable by any member of the cluster, directing each cluster member to disregard the configuration change; and
if each member of the cluster indicates that the configuration change is acceptable, directing each member of the cluster to apply the configuration change.

2. The method of claim 1, wherein sending the configuration change further comprises:
determining if each member of the cluster is in a transaction mode, and if each member is in the transaction mode, sending the configuration change.

3. The method of claim 1, further comprising, sending the configuration change further comprises sending a request for each member of the cluster to transition to a transaction mode.

4. The method of claim 1, wherein at least one member of the cluster is a mobile device.

5. The method of claim 1, wherein the configuration change further comprises at least one of an address change, a host configuration change, an software change, a firmware change a patch, and a time change.

6. The method of claim 1, wherein each member of the cluster indicates that the configuration change is acceptable further comprises, each member of the cluster sending a message.

7. The method of claim 6, wherein the message employs a network protocol.

8. An apparatus for managing a configuration change to a cluster over a network, comprising:
a transceiver for receiving and sending information to a member of the cluster; and
a change manager that is configured to perform actions, including:
determining if each member of the cluster is in transaction mode, and if each member of the cluster is in transaction mode,
sending the configuration change to each member of the cluster,
determining if the configuration change is unacceptable by at least one member of the cluster, and if it is determined that the configuration change is unacceptable by at least one member of the cluster, directing each cluster member to disregard the configuration change, and
if each member of the cluster indicates that the configuration change is acceptable, directing each member of the cluster to commit to the configuration change.

9. The apparatus of claim 8, wherein the apparatus is further configured to communicate with at least one other member of the cluster employing a secure encrypted protocol.

10. The apparatus of claim 8, wherein the apparatus is further configured to operate as a mobile device.

11. The apparatus of claim 8, wherein determining if each member of the cluster is in transaction mode further comprises receiving a message from each member of the cluster.

12. The apparatus of claim 8, wherein the cluster is configured to provide at least one network management service.

13. The apparatus of claim 8, wherein at least one other member of the cluster is configured to perform a lock operation.

14. A modulated data signal for managing a configuration change to a cluster over a network, the modulated data signal comprising the actions of:
receiving at a cluster manager the configuration change;
sending the configuration change to each member of the cluster;
enabling the cluster manager to determine whether the configuration change is unacceptable by any member of the cluster, and if it is determined that the configuration change is unacceptable by any member of the cluster, sending a message indicating that each cluster member is to disregard the configuration change; and
enabling the cluster manager to determine whether the configuration change is acceptable to each member of the cluster, and if it is determined that the configuration change is acceptable to each member of the cluster, directing each member of the cluster to commit to the configuration change.

15. The modulated data signal of claim 14, wherein enabling the cluster manager to determine whether the configuration change is acceptable further comprises receiving a message from each member of the cluster.

16. The modulated data signal of claim 14, wherein enabling the cluster manager to determine whether the configuration change is unacceptable further comprises receiving a message from less than each member of the cluster.

17. The modulated data signal of claim 14, wherein at least one of at least one member of the cluster and the cluster manager and is configured to operate as a mobile device.

18. The modulated data signal of claim 14, wherein at least one member of the cluster is configured to perform at least one of a lock, and a transaction operation.

19. The modulated data signal of claim 14, wherein the configuration change further comprises at least one of an address change, a host configuration change, a version change, a patch, and a time change.

20. An apparatus for managing a configuration change to a cluster over a network, comprising:
a means for sending the configuration change to each member of the cluster;
a means for receiving indication of acceptance of the configuration change from each member of the cluster, and if it indication of acceptance is unreceived for at least one member of the cluster, employing a means for directing each cluster member to disregard the configuration change; and
a means for determining if each member of the cluster indicates that the configuration change is acceptable, and if it is determined that the configuration change is acceptable, employing a means for directing each member of the cluster to commit to the configuration change.
